(19) United States
(12) Patent Application Publication
(10) Pub. No.: US 2022/0400214 A1
(43) Pub. Date: Dec. 15, 2022

(54) SMART PARKING MANAGEMENT SYSTEM AND SMART PARKING MANAGEMENT METHOD

(71) Applicant: PEGATRON CORPORATION, Taipei City (TW)

(72) Inventors: Ying-Hsin Lin, Taiepi City (TW); Chun-Sheng Chao, Taipei City (TW); Yu-Hung Tseng, Taipei City (TW)

(73) Assignee: PEGATRON CORPORATION, TAIPEI CITY (TW)

(21) Appl. No.: 17/727,669

(22) Filed: Apr. 22, 2022

(30) Foreign Application Priority Data
Jun. 15, 2021 (TW) 110121567

(51) Int. Cl. H04N 5/247; G06V 20/62; G08G 1/14

(52) U.S. Cl. CPC H04N 5/247; G06V 20/625; G08G 1/14; G06V 2201/08

(57) ABSTRACT

A smart parking management system and a smart parking management method are provided. The system includes a first smart pole, multiple second smart poles, and a processing device. An image capturing range of the first smart pole covers an entrance of a road section. An image capturing range of each second smart pole covers at least a parking space of the road section. The processing device is communicatively coupled to the first smart pole and the second smart poles. The processing device identifies first vehicle information of a first vehicle entering the road section according to an image stream captured by the first smart pole, obtains a movement trajectory of the first vehicle in the road section based on the first vehicle information and an image stream captured by each second smart pole, and determines where the first vehicle is parked according to the movement trajectory.

### CROSS-REFERENCE TO RELATED APPLICATION

This application claims the priority benefit of Taiwan application serial no. 110121567, filed on Jun. 15, 2021. The entirety of the above-mentioned patent application is hereby incorporated by reference herein and made a part of this specification.

### BACKGROUND

### Technical Field

The disclosure relates to a parking management technology, and more particularly to a smart parking management system and a smart parking management method using smart poles for parking management.

### Description of Related Art

At present, fees of vehicles parked in parking spaces are usually charged manually or through in-ground magnet sensors disposed in parking spaces, parking posts and high-level image recognition systems disposed on the roadside.

However, if fees are charged manually, parking time is calculated from the time when a patrolling parking attendant notices a vehicle is parked in a parking space, instead of being calculated from the time when the vehicle is parked. In this case, payments may not be accurately charged according to the actual parking time of the vehicle. Moreover, the in-ground magnet sensors disposed in the parking space incur further costs and still require a patrolling parking attendant to issue parking tickets since the in-ground magnet sensors cannot detect the license plate of the vehicle in the parking space. The parking posts disposed on the roadside take up pedestrian space on sidewalks. In addition, regarding the high-level image recognition systems, since each high-level camera can only operate independently, if the license plate of the vehicle in the parking space is blocked, the high-level camera may not be able to identify the license plate and charge parking fees.

### SUMMARY

The disclosure provides a smart parking management system and a smart parking management method.

The disclosure provides a smart parking management system, including a first smart pole, multiple second smart poles, and a processing device. The first smart pole includes a first image capturing device and a first communication unit. The first image capturing device is for capturing a first image stream, and a first image capturing range of the first image capturing device covers an entrance of a road section. The first communication unit is coupled to the first image capturing device. The second smart poles are disposed at intervals on a side of the road section, and each second smart pole includes a second image capturing device and a second communication unit. The second image capturing device of each second smart pole is for capturing a second image stream, and a second image capturing range of the second image capturing device covers at least a parking space of the road section. The second communication unit is coupled to the second image capturing device. The processing device is communicatively coupled to the first communication unit and the second communication unit of each second smart pole for identifying first vehicle information of a first vehicle entering the road section according to the first image stream and obtaining a moving trajectory of the first vehicle in the road section based on the first vehicle information and the second image stream captured by each second smart pole. The processing device is further for determining that the first vehicle is parked in the parking space corresponding to a selected second smart pole of the second smart poles according to the movement trajectory of the first vehicle.

The disclosure provides a smart parking management method. In the method, first vehicle information of a first vehicle entering a road section is identified according to a first image stream captured by a first smart pole. An image capturing range of the first smart pole covers an entrance of the road section. Based on the first vehicle information and a second image stream captured by each of multiple second smart poles, a movement trajectory of the first vehicle in the road section is obtained. An image capturing range of each second smart pole covers at least a parking space in the road section. According to the movement trajectory of the first vehicle, it is determined that the first vehicle is parked in the parking space corresponding to a selected second smart pole of the second smart poles.

Based on the above, the disclosure may achieve accurate recording of parking information without additional construction based on existing smart poles disposed at intersections and on both sides of roads.

### BRIEF DESCRIPTION OF THE DRAWINGS

FIG. 1A and FIG. 1B are schematic diagrams of a smart parking management system according to an embodiment of the disclosure.

FIG. 2 is a flowchart of a smart parking management method according to an embodiment of the disclosure.

### DESCRIPTION OF THE EMBODIMENTS

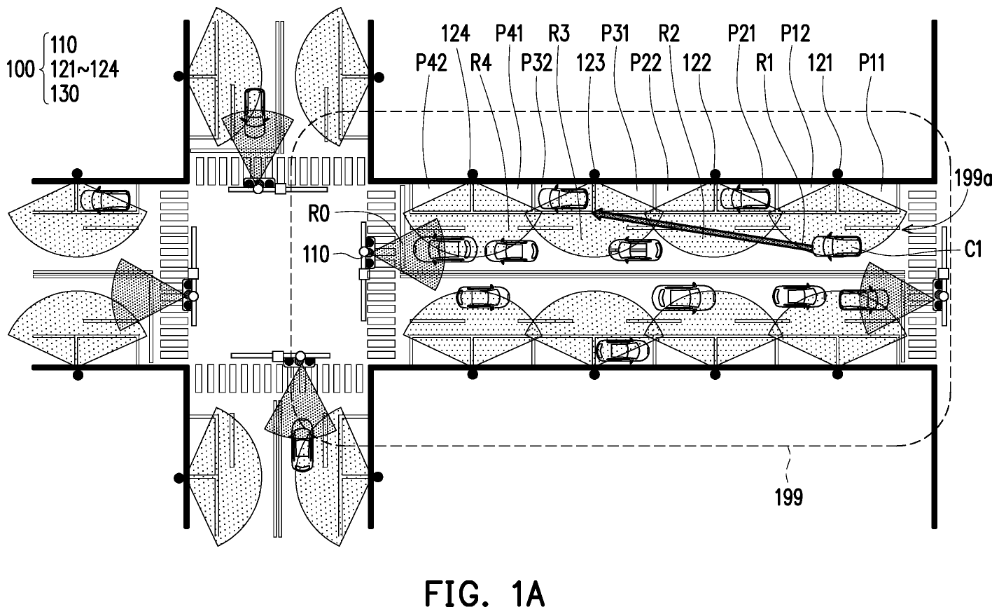

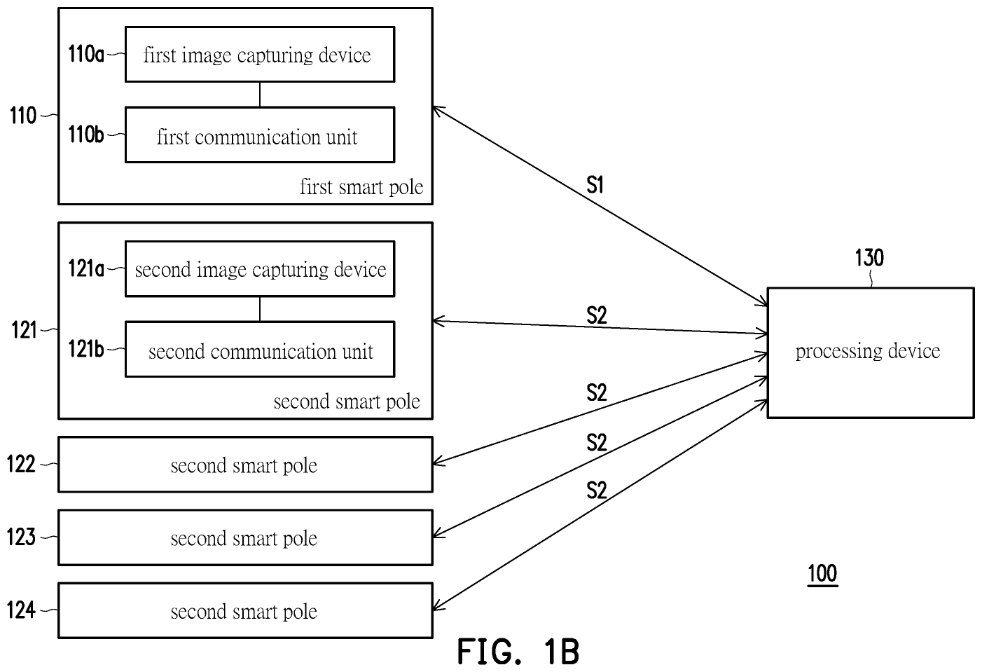

Please refer to FIG. 1A and FIG. 1B. FIG. 1A and FIG. 1B are schematic diagrams of a smart parking management system according to an embodiment of the disclosure. In FIG. 1A and FIG. 1B, a smart parking management system 100 may include a first smart pole 110, second smart poles 121 to 124, and a processing device 130. In some embodiments, the first smart pole 110 may be disposed at the intersection of a road section 199 and may be implemented as a sign pole (such as a traffic light pole) with a communication function, but the disclosure may not be limited thereto. In addition, the second smart poles 121 to 124 may be sequentially disposed at intervals on the roadside of the road section 199, and each of the second smart poles 121 to 124 may be implemented as a light pole with a communication function, but the disclosure may not be limited thereto.

As shown in FIG. 1B, the first smart pole 110 may include a first image capturing device 110a and a first communication unit 110b. In different embodiments, the first image capturing device 110a may be any capturing device with a camera, but the disclosure may not be limited thereto. In addition, the first communication unit 110b may be a communication module capable of providing mobile communication, such as a fifth-generation (5G) communication system module, but the disclosure may not be limited thereto.

Furthermore, since the structures of the second smart poles 121 to 124 are the same, the second smart pole 121 is used as an example for description below. In FIG. 1B, the second smart pole 121 includes a second image capturing device 121a and a second communication unit 121b, which may be implemented with reference to the first image capturing device 110a and the first communication unit 110b respectively, and details are not repeated herein.

In some embodiments, the processing device 130 may be various computer devices and/or smart devices, and the processing device 130 may also include a communication module (including but not limited to a fifth-generation communication system module) capable of communicating with the first communication unit 110b and the second communication units of the second smart poles 121 to 124. In some embodiments, the processing device 130 may also be implemented as a processor (such as a microprocessor unit and/or a central processing unit) and be integrated into the first smart pole 110 and one of the second smart poles 121 to 124, but the disclosure may not be limited thereto.

In some embodiments, the first communication unit 110b of the first smart pole 110, the second communication unit 121b of each of the second smart poles 121 to 124, and the processing device 130 may be communicatively connected to each other for data exchange.

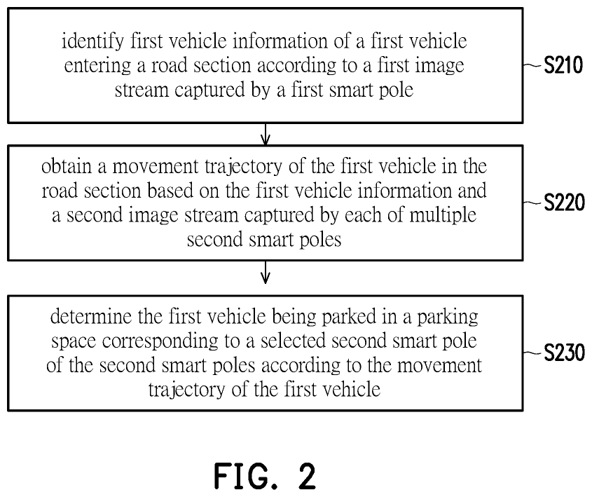

In FIG. 1A, the first image capturing device 110a of the first smart pole 110 has a first image capturing range R0 and may capture a first image stream S1 based on the first image capturing range R0. In an embodiment, the first image capturing range R0 may cover at least the entrance of the road segment 199. In an embodiment, the road section 199 may include a two-lane road. The first image capturing range R0 of the first smart pole 110 may, for example, cover at least one lane 199a of the road section 199, and the image capturing direction of the first smart pole 110 may be opposite to the driving direction of the lane 199a. With FIG. 2A as an example, the driving direction of the lane 199a is, for example, toward the left side of the drawing, and the image capturing direction of the first smart pole 110 may be, for example, toward the right side of the drawing. In this case, assuming that a vehicle C1 enters the lane 199a, the first smart pole 110 may capture the first image stream S1 including the vehicle C1 when the vehicle C1 enters the first image capturing range R0, but the disclosure may not be limited thereto.

In some embodiments, assuming that there is a lane having the same direction next to the lane 199a, the first smart pole 110 may capture an image of the lane 199a and the lane having the same direction before transmitting the image to the processing device 130. The processing device 130 segments the image to distinguish the images of the two lanes, thereby identifying which lane a vehicle is driving on, but the disclosure may not be limited thereto.

In addition, as shown in FIG. 1A, the second smart poles 121 to 124 may be sequentially disposed at intervals on the roadside of the lane 199a. In other words, it is assumed that the second smart poles 121 to 124 include the i^{th} (i is an index value) second smart pole and the (i+1)^{th} second smart pole, and the (i+1)^{th} second smart pole is farther from the entrance of the lane 199a of the road segment 199 than the i^{th} second smart pole. For example, the second smart pole 122 (i.e., the 2^{nd} second smart pole) is farther from the entrance of the lane 199a of the road segment 199 than the second smart pole 121 (i.e., the 1^{st} second smart pole).

In some embodiments, the second image capturing device of each of the second smart poles 121 to 124 has a second image capturing range. The second image capturing range of each of the second smart poles 121 to 124 may cover at least one parking space on the road section 199, and each of the second smart poles 121 to 124 may capture a corresponding second image stream S2 based on the corresponding second image capturing range. For example, a second image capturing range R1 of the second smart pole 121 may cover parking spaces P11 and P12 on the road section 199; a second image capturing range R2 of the second smart pole 122 may cover parking spaces P21 and P22 on the road section 199; a second image capturing range R3 of the second smart pole 123 may cover parking spaces P31 and P32 on the road section 199; a second image capturing range R4 of the second smart pole 124 may cover parking spaces P41 and P42 on the road section 199.

In addition, in some embodiments, the second image capturing ranges of adjacent two of the second smart poles 121 to 124 may cover the same parking spaces. For example, in an embodiment, the second image capturing range R1 of the second smart pole 121 and the second image capturing range R2 of the second smart pole 122 may both cover the parking spaces P12 and P21, but the disclosure may not be limited thereto.

In the embodiments of the disclosure, the smart parking management system 100 may execute the smart parking management method provided in the disclosure, with the details thereof described below.

Please refer to FIG. 2. FIG. 2 is a flowchart of a smart parking management method according to an embodiment of the disclosure. The method of this embodiment may be executed by the first smart pole 110, the second smart poles 121 to 124, and the processing device 130 in FIG. 1 in cooperation. The details of each step in FIG. 2 are described below with the elements shown in FIG. 1A and FIG. 1B.

First, in step S210, the processing device 130 may identify the first vehicle information of the first vehicle entering the road section 199 according to the first image stream S1 captured by the first smart pole 110.

For convenience of description, it is assumed that the vehicle C1 in FIG. 1A is the first vehicle, but the disclosure may not be limited thereto.

Therefore, when the vehicle C1 enters the lane 199a of the road section 199, the processing device 130 may identify the first vehicle information of the vehicle C1 based on the first image stream S1 captured by the first smart pole 110.

In some embodiments, the first vehicle information of the vehicle C1 may include first vehicle identity and first vehicle body information. The first vehicle identity of the vehicle C1 may be the license plate number of the vehicle C1 (hereinafter referred to as PN1), and the first vehicle body information of the vehicle C1 may include at least one of the brand, model, type, and color of the vehicle C1, but the disclosure may not be limited thereto. For convenience of description, it is assumed that the vehicle body information mentioned below is the model and color of the corresponding vehicle, but it is not for limiting the possible implementations of the disclosure.

In an embodiment, the processing device 130 may obtain the first vehicle identity of the vehicle C1 (i.e., the license plate number PN1 of the vehicle C1) and the first vehicle body information of the vehicle C1 (i.e., a model T1 and a color CL1 of the vehicle C1) from the first image stream S1 based on any existing license plate recognition and any vehicle body recognition technology, so the details thereof are not repeated herein.

Next, in step S220, the processing device 130 may obtain the movement trajectory of the first vehicle on the road section 199 based on the first vehicle information and the second image stream S2 captured by each of the second smart poles 121 to 124.

During the movement of the vehicle C1 on the road section 199, the processing device 130 may identify the movement trajectory of the vehicle C1 on the road section 199 based on the second image stream S2 captured by each of the second smart poles 121 to 124.

For example, after obtaining the corresponding second image stream S2 from the i^{th} second smart pole of the second smart poles 121 to 124, the processing device 130 may identify second vehicle body information of a second vehicle appearing in the second image stream S2. In response to determining that the second vehicle body information of the second vehicle matches the first vehicle body information of the vehicle C1, the processing device 130 may determine that the second vehicle is the vehicle C1.

In detail, assuming that a vehicle C1′ enters the second image capturing range R1 of the second smart pole 121, the processing device 130 may obtain the second image stream S2 including the vehicle C1′ from the second smart pole 121 to identify the second vehicle body information of the vehicle C1′ (i.e., a model T1′ and a color CL1′ of the vehicle C1′). Next, the processing device 130 may determine whether the second vehicle body information (i.e., the model T1′ and the color CL1′) of the vehicle C1′ matches the first vehicle body information (i.e., the model T1 and the color CL1) of the vehicle C1.

In an embodiment, in response to determining that the model T1′ and the color CL1′ of the vehicle C1′ respectively match the model T1 and the color CL1 of the vehicle C1, the processing device 130 may accordingly determine that the vehicle C1′ is the vehicle C1. On the other hand, in response to determining that the model T1′ and color CL1′ of the vehicle C1′ do not respectively match the model T1 and the color CL1 of the vehicle C1, the processing device 130 may accordingly determine that the vehicle C1′ is not the vehicle C1. In short, under the situation that license plate recognition is not required, the processing device 130 may determine whether the vehicle C1′ entering the second image capturing range R1 is the vehicle C1 only based on the comparison result of the first vehicle body information of the vehicle C1 and the second vehicle body information of the vehicle C1′, but the disclosure may not be limited thereto.

Therefore, when the vehicle C1 enters the second image capturing range R2 of the second smart pole 122, the processing device 130 may also know that the vehicle C1 has entered the second image capturing range R2 based on the above teaching. From another point of view, when the vehicle C1 enters the second image capturing range R2, it also means that the movement trajectory of the vehicle C1 has passed through the second image capturing range R2 of the second smart pole 122.

In an embodiment, assuming that the processing device 130 has detected the vehicle C1 corresponding to the first vehicle body information (i.e., the model T1 and the color CL1) in the second image stream S2 captured by each of the first second smart pole to the i^{th} second smart pole of the second smart poles 121 to 124 but has not detected any vehicle corresponding to the first vehicle body information in the second image stream S2 captured by the (i+1)^{th} second smart pole of the second smart poles 121 to 124, then the processing device 130 may determine that the movement trajectory of the vehicle C1 indicates that the vehicle C1 is parked in the parking space corresponding to the i^{th} second smart pole, and the i^{th} second smart pole is a selected second smart pole.

Next, in step S230, the processing device 130 may determine that the first vehicle is parked in the parking space corresponding to the selected second smart pole of the second smart poles 121 to 124 according to the movement trajectory of the first vehicle.

In the scenario of FIG. 1A, it is assumed that the vehicle C1 is parked in the parking space P32 in the second image capturing range R3 after passing through the second image capturing ranges R1 and R2. In this case, the processing device 130 detects the vehicle C1 corresponding to the model T1 and the color CL1 in the second image stream S2 captured by each of the second smart poles 121 to 123 but does not detect any vehicle corresponding to the model T1 and the color CL1 in the second image stream S2 captured by the second smart pole 124. Therefore, the processing device 130 may determine that the movement trajectory of the vehicle C1 indicates that the vehicle C1 is parked in the parking space corresponding to the second smart pole 123 and accordingly determine that the second smart pole 123 is the selected second smart pole.

In an embodiment, when a vehicle enters any parking space in FIG. 1A, the processing device 130 may determine whether the vehicle has stopped in the parking space for a preset time (such as 3 minutes) based on the second image stream S2 captured by the corresponding second smart pole. For example, after the vehicle C1 enters the parking space P32, the processing device 130 may determine whether the vehicle C1 has stopped in the parking space P32 for the preset time based on the second image stream S2 from the second smart pole 123. If so, the processing device 130 may accordingly determine that the vehicle C1 has been parked in the parking space P32, otherwise the processing device 130 may determine that the vehicle C1 has not been parked in the parking space P32.

In an embodiment, when the vehicle is determined to be parked in the parking space P32, the processing device 130 may have not confirmed that the vehicle currently parked in the parking space P32 (hereinafter referred to as a third vehicle) is the vehicle C1 yet. Therefore, in an embodiment, in response to determining that the third vehicle has been parked in the parking space P32 based on the second image stream S2 captured by the second smart pole 123, the processing device 130 may identify third vehicle body information of the third vehicle and determine whether the third vehicle body information matches the first vehicle body information of the vehicle C1. In response to determining that the third vehicle body information matches the first vehicle body information, the processing device 130 may determine that the third vehicle parked in the parking space P32 is the vehicle C1, otherwise the processing device 130 may determine that the third vehicle parked in the parking space P32 is not the vehicle C1.

Next, the processing device 130 may record the parking information of the first vehicle parked in the parking space corresponding to the selected second smart pole. In some embodiments, the parking information of the first vehicle parked in the parking space corresponding to the selected second smart pole may include the first vehicle identity of the first vehicle, an identifier of the parking space corresponding to the selected second smart pole, and the initial parking time of the first vehicle in the parking space corresponding to the selected second smart pole.

In FIG. 1A, since it is assumed that the vehicle C1 is parked in the parking space P32, the processing device 130 may, after determining that the vehicle C1 has been parked in the parking space P32, record the parking information of the vehicle C1 parked in the parking space P32, such as the first vehicle identity of the vehicle C1, the identifier of the parking space P32, and the initial parking time of the vehicle C1 in the parking space P32, but the disclosure may not be limited thereto.

In an embodiment, assuming that the usage of each parking space on the road section 199 may be collected onto a parking space management platform, the processing device 130 may, after determining that the vehicle C1 has been parked in the parking space P32, mark the parking space P32 as occupied on the parking space management platform. In this way, other users may know which parking spaces are occupied with reference to the parking space management platform.

In an embodiment, after determining that the vehicle C1 has left the parking space P32, the processing device 130 may also record the end parking time of the vehicle C1 in the parking space P32. In addition, the processing device 130 may also mark the parking space P32 as vacant on the parking space management platform. In this way, other users may know which parking spaces are available for parking with reference to the parking space management platform. In addition, the processing device 130 may further send relevant parking charge information to the owner of the vehicle C1 according to the initial parking time and the end parking time of the vehicle C1 in the parking space P32, but the disclosure may not be limited thereto.

In summary, in the embodiments of the disclosure, after the first vehicle enters the road section, the processing device may identify the first vehicle based on the first image stream captured by the first smart pole disposed at the intersection to obtain the first vehicle information of the first vehicle. Next, the processing device may detect that the second vehicle enters the corresponding second image capturing range based on the second image stream captured by the second smart pole disposed on the roadside, and may determine whether the second vehicle body information of the second vehicle matches the first vehicle body information of the first vehicle to know whether the second vehicle is the first vehicle. If it is determined that the second vehicle is the first vehicle, the processing device may obtain the first vehicle identity of the first vehicle from the first smart pole and know the movement trajectory of the first vehicle based on the second image streams captured by the other second smart poles.

If the processing device determines that the first vehicle has been parked in the specific parking space managed by the processing device, the processing device may record the relevant parking information of the first vehicle parked in the specific parking space. In this way, accurate recording of parking information may be achieved without manual intervention and additional construction. Moreover, since the first smart pole and the second smart pole may be implemented as signal poles at intersections and light poles on roadside, there is no need to occupy additional space on sidewalks. In addition, since availability of each parking space may be recorded on the parking space management platform by the corresponding second smart pole, the convenience for a user to find a parking space may further be improved.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A smart parking management system, comprising:
a first smart pole, comprising:
a first image capturing device, configured to capture a first image stream, wherein an image capturing range of the first image capturing device covers an entrance of a road section; and
a first communication unit, coupled to the first image capturing device;
a plurality of second smart poles, disposed at intervals on a side of the road section, wherein each of the plurality of second smart poles comprises:
a second image capturing device, configured to capture a second image stream, wherein an image capturing range of the second image capturing device covers at least a parking space in the road section; and
a second communication unit, coupled to the second image capturing device; and
a processing device, communicatively coupled to the first communication unit and the second communication unit of each of the plurality of second smart poles, wherein the processing device is configured to:
identify first vehicle information of a first vehicle entering the road section according to the first image stream;
obtain a movement trajectory of the first vehicle in the road section based on the first vehicle information and the second image stream captured by each of the plurality of second smart poles; and
determine the first vehicle being parked in the parking space corresponding to a selected second smart pole of the plurality of second smart poles according to the movement trajectory.

2. The smart parking management system according to claim 1, wherein the first vehicle information of the first vehicle comprises first vehicle identity and first vehicle body information of the first vehicle.

3. The smart parking management system according to claim 2, wherein the first vehicle identity is a license plate number of the first vehicle, and the first vehicle body information comprises at least one of brand, model, type, and color of the first vehicle.

4. The smart parking management system according to claim 2, wherein the processing device is further configured to:
obtain the second image stream corresponding to one of the plurality of second smart poles, and identifying second vehicle body information of a second vehicle appearing in the second image stream; and
determine the second vehicle as the first vehicle in response to the second vehicle body information of the second vehicle matching the first vehicle body information of the first vehicle.

5. The smart parking management system according to claim 1, wherein the plurality of second smart poles comprise an i^{th} second smart pole and an (i+1)^{th} second smart pole, and the (i+1)^{th} second smart pole is farther from the entrance of the road section than the i^{th} second smart pole, wherein the step of determining the first vehicle being parked in the parking space corresponding to the selected second smart pole by the processing device comprises:
in response to the first vehicle corresponding to the first vehicle body information being detected in the second image streams captured by a 1^{st} second smart pole to the i^{th} second smart pole of the plurality of second smart poles respectively but no vehicle corresponding to the first vehicle body information being detected in the second image stream captured by the (i+1)^{th} second smart pole, determining the first vehicle being parked in the parking space corresponding to the i^{th} second smart pole, wherein the i^{th} second smart pole is the selected second smart pole.

6. The smart parking management system according to claim 1, wherein the processing device is further configured to obtain parking information of the first vehicle parked in the parking space corresponding to the selected second smart pole, wherein the parking information comprises the first vehicle identity of the first vehicle, an identifier of the parking space, and an initial parking time of the first vehicle in the parking space.

7. The smart parking management system according to claim 6, wherein the processing device is further configured to record an end parking time of the first vehicle in the parking space and calculating a parking time of the first vehicle in the parking space corresponding to the selected second smart pole in response to determining the first vehicle having left the parking space corresponding to the selected second smart pole.

8. The smart parking management system according to claim 7, wherein the processing device is further configured to mark the parking space corresponding to the selected second smart pole as vacant on a parking space management platform after determining the first vehicle having left the parking space corresponding to the selected second smart pole.

9. The smart parking management system according to claim 1, wherein the processing device is further configured to mark the parking space corresponding to the selected second smart pole as occupied on a parking space management platform.

10. The smart parking management system according to claim 1, wherein the first image capturing device faces the entrance of the road section.

11. The smart parking management system according to claim 1, wherein the first smart pole is a sign pole with a communication function, and each of the plurality of second smart poles is a light pole with a communication function.

12. A smart parking management method, adapted for a smart parking management system, the smart parking management method comprising:
identifying first vehicle information of a first vehicle entering a road section according to a first image stream captured by a first smart pole, wherein an image capturing range of the first smart pole covers an entrance of the road section;
obtaining a movement trajectory of the first vehicle in the road section based on the first vehicle information and a second image stream captured by each of a plurality of second smart poles, wherein an image capturing range of each of the plurality of second smart poles covers at least a parking space in the road section; and
determining the first vehicle being parked in the parking space corresponding to a selected second smart pole of the plurality of second smart poles according to the movement trajectory.

13. The smart parking management method according to claim 12, wherein the first vehicle information of the first vehicle comprises first vehicle identity and first vehicle body information of the first vehicle.

14. The smart parking management method according to claim 13, further comprising:
obtaining the second image stream corresponding to one of the plurality of second smart poles, and identifying second vehicle body information of a second vehicle appearing in the second image stream; and
determining the second vehicle as the first vehicle in response to the second vehicle body information of the second vehicle matching the first vehicle body information of the first vehicle.

15. The smart parking management method according to claim 13, wherein the plurality of second smart poles comprise an i^{th} second smart pole and an (i+1)^{th} second smart pole, the (i+1)^{th} second smart pole is farther from the entrance of the road section than the i^{th} second smart pole, and the step of determining the first vehicle being parked in the parking space corresponding to the selected second smart pole comprises:
in response to the first vehicle corresponding to the first vehicle body information being detected in the second image streams captured by a 1^{t} second smart pole to the i^{th} second smart pole of the plurality of second smart poles respectively buts no vehicle corresponding to the first vehicle body information being detected in the second image stream captured by the (i+1)^{th} second smart pole, determining the first vehicle being parked in the parking space corresponding to the i^{th} second smart pole, wherein the i^{th} second smart pole is the selected second smart pole.

16. The smart parking management method according to claim 13, further comprising:
obtaining parking information of the first vehicle parked in the parking space corresponding to the selected second smart pole, wherein the parking information comprises the first vehicle identity of the first vehicle, an identifier of the parking space, and an initial parking time of the first vehicle in the parking space corresponding to the selected second smart pole.
